(19) United States
(12) Patent Application Publication
(10) Pub. No.: US 2014/0273681 A1
(43) Pub. Date: Sep. 18, 2014

(54) SIC BASED CERAMIC MATRIX COMPOSITES WITH LAYERED MATRICES AND METHODS FOR PRODUCING SIC BASED CERAMIC MATRIX COMPOSITES WITH LAYERED MATRICES

(71) Applicant: Rolls-Royce Corporation, Indianapolis, IN (US)

(72) Inventors: Adam L. Chamberlain, Mooresville, IN (US); Andrew J. Lazur, Huntington Beach, CA (US)

(73) Assignee: Rolls-Royce Corporation, Indianapolis, IN (US)

(21) Appl. No.: 14/207,046

(22) Filed: Mar. 12, 2014

Related U.S. Application Data
(60) Provisional application No. 61/788,796, filed on Mar. 15, 2013.

(51) Int. Cl. C04B 35/80

(52) U.S. Cl. CPC C04B 35/80
USPC 442/1; 428/293.4; 428/392; 428/366; 428/368

(57) ABSTRACT

Ceramic matrix composites include a fiber network and a matrix including layers of first and second materials. The first material may include SiC. The second material may include an element that when oxidized forms a silicate that is stable at high temperatures.

### RELATED APPLICATIONS

This application is related to and claims priority to U.S. Provisional Patent Application Ser. No. 61/788,796, filed on Mar. 15, 2013 entitled “Sic Based Ceramic Matrix Composites With Layered Matrices and Methods for Producing Sic Based Ceramic Matrix Composites With Layered Matrices.” The subject matter disclosed in that provisional application is hereby expressly incorporated into the present application in its entirety.

### FIELD OF THE DISCLOSURE

The present disclosure relates generally to ceramic matrix composites, and more specifically to silicon carbide based ceramic matrix composites with layered matrices.

### BACKGROUND

Ceramic Matrix Composites (CMS's) are materials that include ceramic fibers embedded in a ceramic matrix. CMC's typically exhibit desirable mechanical, chemical and physical properties at high temperatures. For example, CMS's are typically more resistant to oxidation at high temperatures than are metals. CMC's are generally tougher than monolithic ceramics and exhibit damage tolerance. SiC/SiC CMC's are one example of a composite material that exhibits excellent high temperature mechanical, physical and chemical properties. Such materials are suitable for a number of high temperature applications, such as use in producing hot sector components of gas turbine engines. SiC/SiC CMC engine components allow gas turbine engines to operate at much higher temperatures than engines having superalloy metal components.

Although SiC/SiC CMC's are typically more resistant to oxidation than metals, they do suffer from active oxidation when exposed to the environment of a turbine engine. The active oxidation is a result of the instability of silicon dioxide (SiO₂) when exposed to the high gas velocity and pressures of the engine environment. Active oxidation can cause recession of components during operation, which can eventually lead to failure.

### SUMMARY

The present application discloses one or more of the features recited in the appended claims and/or the following features which, alone or in any combination, may comprise patentable subject matter.

A method for producing a ceramic matrix composite may include the steps of forming a network of fibers, depositing a first matrix layer on the fibers and depositing a second matrix layer containing an element that when oxidized forms a silicate that is stable at high temperatures.

In some embodiments, the first matrix layer is SiC.

In some embodiments, the second matrix layer is SiNC doped with an element that when oxidized forms a silicate that is stable at high temperatures. In other embodiments, the second matrix layer is Si₃N₄ doped with an element that when oxidized forms a silicate that is stable at high temperatures. In some embodiments, the element may be yttrium, ytterbium, dysprosium, erbium, gadolinium, scandium, lanthanum, cerium, praseodymium, neodymium, promethium, samarium, europium, terbium, holmium, thulium, lutetium, zirconium, niobium, molybdenum, hafnium, tantalum, rhenium, tin, selenium or tellurium.

In some embodiments, the method further includes the step of depositing an interface layer on the fiber network before depositing the matrix layers. In some embodiments, the interface layer includes boron nitride. In other embodiments, the interface layer includes pyrolitic carbon.

In some embodiments of the invention the matrix layers are deposited by chemical vapor infiltration.

In some embodiments, the method includes further processing the ceramic matrix composite by polymer infiltration and pyrolysis, slurry infiltration, melt infiltration and/or heat treating.

A ceramic matrix composite may include a network of fibers, a first matrix layer and a second matrix layer containing an element that when oxidized forms a silicate that is stable at high temperatures.

In some embodiments, the first matrix layer is SiC.

In some embodiments, the second matrix layer is SiNC doped with an element that when oxidized forms a silicate that is stable at high temperatures. In other embodiments, the second matrix layer is Si₃N₄ doped with an element that when oxidized forms a silicate that is stable at high temperatures. In some embodiments, the element may be yttrium, ytterbium, dysprosium, erbium, gadolinium, scandium, lanthanum, cerium, praseodymium, neodymium, promethium, samarium, europium, terbium, holmium, thulium, lutetium, zirconium, niobium, molybdenum, hafnium, tantalum, rhenium, tin, selenium or tellurium.

In some embodiments, the ceramic matrix composite may include an interface layer between the fibers and the first matrix layer. In some embodiments, the interface layer includes boron nitride. In other embodiments, the interface layer includes pyrolitic carbon.

A ceramic matrix composite may include a plurality of fibers, individual first matrix layers surrounding each fiber and individual second matrix layers surrounding each of the individual first matrix layers, the individual second matrix layers including an element that when oxidized forms a silicate that is stable at high temperatures.

In some embodiments, the first individual matrix layers are SiC.

In some embodiments, the second individual matrix layers are SiNC doped with. In other embodiments, the second individual matrix layers are Si₃N₄ doped with an element that when oxidized forms a silicate that is stable at high temperatures. In some embodiments, the element may be yttrium, ytterbium, dysprosium, erbium, gadolinium, scandium, lanthanum, cerium, praseodymium, neodymium, promethium, samarium, europium, terbium, holmium, thulium, lutetium, zirconium, niobium, molybdenum, hafnium, tantalum, rhenium, tin, selenium and tellurium.

In some embodiments, the ceramic matrix composite may include individual interface layers between the fibers and the first individual matrix layers. In some embodiments the individual interface layers include boron nitride. In other embodiments, the individual interface layers include pyrolitic carbon.

A ceramic matrix composite may include a first fiber, a first matrix layer surrounding the first fiber and a second matrix layer surrounding the first matrix layer, the second matrix layer including an element that when oxidized forms a silicate that is stable at high temperatures. The ceramic matrix composite may include a second fiber, a third matrix layer surrounding the second fiber and a fourth matrix layer surrounding the third matrix layer, the fourth matrix layer including an element that when oxidized forms a silicate that is stable at high temperatures. A fifth matrix layer may surround the second matrix layer and the fourth matrix layer.

In some embodiments the ceramic matrix composite may include a sixth matrix layer surrounding the fifth matrix layer.

In some embodiments, the first, third and/or fifth matrix layers may be SiC.

In some embodiments, the second, fourth and/or sixth matrix layers may be SiNC doped with an element that when oxidized forms a silicate that is stable at high temperatures.

In some embodiments, the second, fourth and/or sixth matrix layers may be Si₃N₄ doped with an element that when oxidized forms a silicate that is stable at high temperatures.

A ceramic matrix composite may include a network of fibers, a first matrix layer, the first matrix layer including silica and a second matrix layer, the second matrix layer including a silicate.

A method for producing a ceramic matrix composite may include the steps of forming a network of fibers, depositing a silica matrix layer on the fibers and depositing a silicate matrix layer on the fibers.

These and other features of the present disclosure will become more apparent from the following description of the illustrative embodiments.

### BRIEF DESCRIPTION OF THE DRAWINGS

FIG. 1 is a flow chart illustrating a process for producing silicon carbide based ceramic matrix composites with layered matrices;

FIG. 2 illustrates the microstructure of a ceramic matrix composite with layered matrices; and

FIG. 3 illustrates the microstructure of ceramic matrix composite fibers with individual layered matrices according to an embodiment of the present invention.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

A process for producing layered ceramic matrix composites is shown in FIG. 1. In Step 1 of the process, a fiber network is produced. For example, the fiber network can be a near net shape preform of a component. Fiber volume may range between about 15% and about 50%. More specifically, the fiber volume will typically range between about 30% and about 40%. In certain embodiments of the invention, the fibers are stoichiometric or non-stoichiometric SiC fibers, SiCN fibers or silicon oxycarbide fibers.

The fiber preform may be coated with one or more interface coatings (Step 2). For example, the preform may be coated with boron nitride (BN) or pyrolitic carbon. The interface coatings can be selected to perform a number of functions, such as resisting crack propagation, increasing toughness of the matrix, improving bonding between the matrix and the fibers or producing other desirable results. The fibers may be coated by CVI or other methods.

The preform is then coated with alternating layers of silicon carbide and silicon carbonitride (SiNC) doped with one or more elements that when oxidized form a silicate that is stable at high temperatures. Alternatively, the preform can be coated with alternating layers of silicon carbide and silicon nitride (Si₃N₄) doped with one or more elements that when oxidized form a silicate that is stable at high temperatures. As another alternative, the preform can be coated with alternating layers of SiC, SiNC doped with one or more elements that when oxidized form a silicate that is stable at high temperatures and Si₃N₄ doped with one or more elements that when oxidized form a silicate that is stable at high temperatures. (Step 3) Examples of elements that when oxidized form a silicate that is stable at high temperatures include yttrium (Y), ytterbium (Yb), dysprosium (Dy), erbium (Er), gadolinium (Gd), scandium (Sc), lanthanum (La), cerium (Ce), praseodymium (Pr), neodymium (Nd), promethium (Pm), samarium (Sm), europium (Eu), terbium (Tb), holmium (Ho), thulium (Tm), lutetium (Lu), zirconium (Zr), niobium (Nb), molybdenum (Mo), hafnium (Hf), tantalum (Ta), rhenium (Re), tin (Sn), selenium (Se) and/or tellurium (Te). The layers may be deposited by chemical vapor infiltration (CVI). The Si₃N₄ and SiNC layers in certain embodiments contain up to about 25 atomic percent of the doping element.

The CMC may undergo further processing after deposition of the matrix material. (Step 4) For example, the CMC may be further processed by polymer infiltration and pyrolysis (PIP), slurry infiltration, melt infiltration, further CVI, heat treating to obtain a desired material microstructure or combinations of the foregoing.

When the SiC layers are exposed to oxidizing conditions, they will form silica, which is an effective barrier to oxygen diffusion. The doped Si₃N₄ and/or SiNC layers will form silicates, which are effective barriers to steam diffusion. As an alternative to the methods described above matrix layers of silica and silicates that are stable at high temperatures could be deposited directly on the fibers.

The following are theoretical examples of CMC's and methods for producing CMC's according to certain embodiments of the invention.

### Example 1

A preform for a component, such as a component of a gas turbine engine, is produced from a silicon carbide fiber. The preform is approximately 35% fiber volume. The preform is then coated with a with boron nitride or pyrolitic carbon interface layer. After application of the interface layer, a layered matrix is produced by depositing alternating layers of SiC, SiCN doped with an element that when oxidized forms a silicate that is stable at high temperatures and/or Si₃N₄ doped with an element that when oxidized forms a silicate that is stable at high temperatures on the preform via chemical vapor infiltration (CVI). The doping element may be introduced into the SiNC and Si₃N₄ layers by addition of an appropriate gas stream during CVI. For example, yttrium could be added by introducing yttrium chloride gas. This process results in layers containing a silicide of the doping element in combination with SiC, SiNC, or Si₃N₄. Alternatively, a carbide, boride or nitride of the doping element could be deposited to achieve similar properties.

The final microstructure of the CMC is represented by FIG. 2. The microstructure includes fibers 10, interface coating 20, first SiC layer 30, first doped SiNC or doped Si₃N₄ layer 40, second SiC layer 50 and second doped SiNC or doped Si₃N₄ layer 60. Note that additional layers can be applied. In this example, first SiC layer 30 is approximately 2% to approximately 40% of the total composite volume. More typically, first SiC layer 30 is 10% to approximately 20% of the total composite volume. The remaining layered structure is approximately 10% to 45% of the composite volume, the amount being dependant on the desired final properties. The thickness of each layer ranges between about 0.1 microns and about 10 microns.

After CVI deposition is complete, the composite may be heat treated to reduce chemical gradients. Heat treatment temperatures are typically in the range of about 2200° F. to about 3000° F.

### Example 2

As an alternative, individual doped SiCN layers and/or doped Si₃N₄ layers can be deposited around individual fibers. This can be done immediately after depositing one or more interface layers or after depositing individual SiC layers approximately 0.1 um to approximately 5 um around the fibers. A resulting fiber with individual layered matrices is illustrated in FIG. 3. As shown in FIG. 3, fiber 110, is surrounded by interface coating 120, first SiC layer 130, first doped SiNC or doped Si₃N₄ layer 140, second SiC layer 150 and second doped SiNC or doped Si₃N₄ layer 160. The individual fibers coated in this manner can be further embedded in a matrix of alternating layers of SiC, doped SiNC and/or doped Si₃N₄ like the fibers in the embodiment of FIG. 2.

### Example 3

As another alternative, improved oxidation resistance can be achieved by depositing only doped Si₃N₄ or doped SiNC onto the fibers and eliminating the SiC layers.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A ceramic matrix composite, including:
a network of fibers;
a first matrix layer; and
a second matrix layer containing an element that when oxidized forms a silicate that is stable at high temperatures.

2. The ceramic matrix composite of claim 2, wherein the first matrix layer is SiC.

3. The ceramic matrix composite of claim 1, wherein the second matrix layer is SiNC doped with an element that when oxidized forms a silicate that is stable at high temperatures.

4. The ceramic matrix composite of claim 1, wherein the second matrix layer is Si₃N₄ doped with an element that when oxidized forms a silicate that is stable at high temperatures.

5. The ceramic matrix composite of claim 1, further including an interface layer between the fibers and the first matrix layer.

6. The ceramic matrix composite of claim 5, wherein the interface layer includes boron nitride.

7. The ceramic matrix composite of claim 5, wherein the interface layer includes pyrolitic carbon.

8. The ceramic matrix composite of claim 1, wherein the element that when oxidized forms a silicate that is stable at high temperatures is selected from the group consisting of yttrium, ytterbium, dysprosium, erbium, gadolinium, scandium, lanthanum, cerium, praseodymium, neodymium, promethium, samarium, europium, terbium, holmium, thulium, lutetium, zirconium, niobium, molybdenum, hafnium, tantalum, rhenium, tin, selenium and tellurium.

9. A ceramic matrix composite, including:
a plurality of fibers;
individual first matrix layers surrounding each fiber; and
individual second matrix layers surrounding each of the individual first matrix layers, the individual second matrix layers including an element that when oxidized forms a silicate that is stable at high temperatures.

10. The ceramic matrix composite of claim 9, wherein the first individual matrix layers are SiC.

11. The ceramic matrix composite of claim 9, wherein the second individual matrix layers are SiNC doped with an element that when oxidized forms a silicate that is stable at high temperatures.

12. The ceramic matrix composite of claim 9, wherein the second individual matrix layers are Si₃N₄ doped with an element that when oxidized forms a silicate that is stable at high temperatures.

13. The ceramic matrix composite of claim 9, further including individual interface layers between the fibers and the first individual matrix layers.

14. The ceramic matrix composite of claim 13, wherein the individual interface layers include boron nitride.

15. The ceramic matrix composite of claim 13, wherein the individual interface layers include pyrolitic carbon.

16. The ceramic matrix composite of claim 9, wherein the element is selected from the group consisting of yttrium, ytterbium, dysprosium, erbium, gadolinium, scandium, lanthanum, cerium, praseodymium, neodymium, promethium, samarium, europium, terbium, holmium, thulium, lutetium, zirconium, niobium, molybdenum, hafnium, tantalum, rhenium, tin, selenium and tellurium.

17. A ceramic matrix composite, comprising:
a first fiber;
a first matrix layer surrounding the first fiber;
a second matrix layer surrounding the first matrix layer, the second matrix layer including an element that when oxidized forms a silicate that is stable at high temperatures;
a second fiber;
a third matrix layer surrounding the second fiber;
a fourth matrix layer surrounding the third matrix layer, the fourth matrix layer including an element that when oxidized forms a silicate that is stable at high temperatures; and
a fifth matrix layer surrounding the second matrix layer and the fourth matrix layer.

18. The ceramic matrix composite of claim 17, further including a sixth matrix layer surrounding the fifth matrix layer.

19. The ceramic matrix composite of claim 17, wherein the first matrix layer is SiC.

20. The ceramic matrix composite of claim 17, wherein the third matrix layer is SiC.
